(19) United States
(12) Patent Application Publication
(10) Pub. No.: US 2015/0045102 A1
(43) Pub. Date: Feb. 12, 2015

(54) KENO WITH ROULETTE CONTENT WAGERS

(71) Applicants: Ray Smith, Linden, NJ (US); Amanda Tears Smith, Linden, NJ (US)

(72) Inventors: Ray Smith, Linden, NJ (US); Amanda Tears Smith, Linden, NJ (US)

(21) Appl. No.: 13/964,537

(22) Filed: Aug. 12, 2013

(51) Int. Cl. G07F 17/32

(52) U.S. Cl. CPC G07F 17/3286
USPC 463/19

(57) ABSTRACT

A method of playing a side bet wagering game on a gaming system comprising a video display system, a processor and a data entry input system at a defined location. Separate wagers are placed on an underlying keno game or bingo game and a separate roulette game using alphanumerics selected in the keno game to resolve roulette wagers. A Keno game with 40 (plus two additional alphanumerics) or 80 alphanumerics (with 2 or four additional alphanumerics, such as 0, 00, X, XX) may be used. The processor randomly selects at least 10 or 20 alphanumerics to resolve the 40 keno wager. A predetermined one of the at least 10 or alphanumerics is used to resolve the roulette game.

### BACKGROUND OF THE INVENTION

1. Field of the Invention

The present invention relate to the field of wagering games, particularly casino wagering games having a keno content and more particularly to keno games in which roulette-type wagers may be placed on keno numbers during play of the keno game.

2. Background of the Art

Keno is similar to Lotto. It was first introduced in China many years ago. The game was brought to the United States in the mid 1800's by Chinese immigrants who came to work in the mines and on the railroad. It is a very popular game and very easy to play. It is an exciting pastime and, most importantly, it offers the possibility of winning large payouts on relatively small wagers.

Keno is usually played in Casino lounges specifically allocated for the game, but there are so-called ‘Keno runners’ who will collect tickets and deliver the winnings if the player wants to play from outside the lounge area. There are many television monitors spread all over the Casino halls to keep players informed of the winning numbers. There is also the video version of Keno. These are video slot-like coin, credit or ticket-in operated machines. It plays using the same principle with similar rules of the regular Keno, but the results occur much faster.

To play Keno, a player selects a minimum of 4 but no more than 10 numbers between 1 and 80. Each selection is called a ‘Spot’, so if 10 numbers are selected, a 10 Spot game is being played. Keno tickets are located at tables throughout the Casino and in the Casino's Keno lounge. The Casino provides a ‘Keno crayon’ for this purpose. A player simply marks a blank Keno ticket (or virtual electronic ticket on a gaming device) with the numbers of the selection. The ticket is presented to the Keno desk (or received by a processor that executes code to effect game play) with the wager and the clerk provides a duplicate ticket (or the processor indicates the selections on the video display). In a few minutes (or in less than a minute on electronic play), twenty numbered Keno balls will be drawn at random from a barrel containing 80 numbered balls (or 20 virtual balls or 20 random numbers are provided by a random number generator associated with and in communication with the processor), and if enough of the selected numbers are drawn, a winning event outcome occurs. The results are displayed on screens (or the video screen), called Keno boards, throughout the Casino.

Minimum bets can be as low as 5 cents, although some Casinos only accept bets of $1 or more. The house's Keno brochures give information about payoffs and various tickets that can be played. The amount of money won is dependent upon the type of ticket played and the number of ‘spots’ caught. A player may wager on as many tickets as desired. One could win as much as $50,000 on a $1 wager in some Casinos.

The round of a Keno game is called a Keno race. In many Casinos, ‘multi-race’ Keno is featured, where one can play a number of consecutive Keno races at one time. The house advantage on Keno varies according to the Keno game played. It is always around 30% or more. The chance of hitting one number in 80 is 0.25.

Many variants and side bet or bonus games have been developed for play with Keno. Published U.S. Patent Application Document No. 20080070670 (Brunelle) describes a keno game including a set of playable symbols, from which a set of player symbols are selected. A set of winning symbols are selected from a set of potential winning symbols, with the set of potential winning symbols including the set of playable symbols and at least one wild symbol. The wild symbol may match any one of the player symbols, none of the player symbols, or a range of player symbols. The playable symbols are preferably numbers. Payouts preferably follow a pay table having a weighted probability based on the total number of symbols in the set of potential winning symbols.

Published U.S. Patent Application Document No. 20070173312 (Dodge) describes a novel Keno game wherein a player selects up to ten numbers from a field of eighty numbers to be played and these numbers are compared to twenty numbers randomly selected by the game from the same field of numbers in a manner known in the prior art. When the player places one or more conventional bets on the outcome of the game, they now also place one or more side bets as to the number of hits or matches there will be between the player selected numbers and twenty numbers selected by the game computer. The player may place side bets on more than one number of hits or matches to increase their odds of achieving side bet winnings.

Published U.S. Patent Application Document No. 20090197664 (Schultz) discloses a keno game having a bonus round. The keno game provides a player with an additional opportunity to win, after the keno balls have been drawn, to add excitement and volatility to the standard keno game. According to one method, the gaming machine receives the player's input, with the player selecting one or more numbers. A keno draw, which includes a plurality of numbers from a keno pool, is then displayed to the player. A bonus round is initiated in response to a trigger event. The bonus round is a random selection of one or more numbers in addition to the numbers previously selected from the keno draw. The numbers selected from the bonus round are displayed to the player. The numbers selected by the player are evaluated again the numbers from the keno draw results as well as the bonus round, and a payout for any winning outcomes are awarded to the player.

Published U.S. Patent Application Document No. 20060178196 (Thomas) describes a method of playing a keno-type wagering game. The method includes conducting the keno-type wagering game at a gaming terminal. The keno-type wagering game has a plurality of game cards and a plurality of symbols. At least some of the plurality of symbols to be used by a player in the wagering game is displayed to the player. A first set of symbols from the plurality of symbols is selected, and applies to all of the plurality of game cards. The method further includes randomly generating a plurality of second sets of symbols from the plurality of symbols. Each of the plurality of second sets includes a first symbol and each of the first symbols of each of the plurality of second sets is displayed simultaneously. In response to at least one of the symbols of the plurality of second sets matching a symbol from the first set, the player receives an award.

Additional variations in the play of casino games, including Keno are desired in the art. All references cited herein are incorporated in their entirety by reference.

### SUMMARY OF THE INVENTION

A method of playing a side bet wagering game on a gaming system using a video display system, a processor and a data entry input system at a defined location. Separate wagers are placed on an underlying keno or bingo game and a separate roulette-style game using alphanumeric symbols (alphanumerics defined as numbers, letters, characters, simple images and symbols) selected in the keno game to resolve roulette-style wagers. A Keno game with 40 (plus one or two additional alphanumerics) or 80 alphanumerics (with 2 or four additional alphanumerics, such as 0, 00, X, XX) may be used. The processor randomly selects at least 10 or 20 alphanumerics to resolve the 40 or 80 number (or alternatively symbol) keno wager. A predetermined one or more of the at least 10 or 20 alphanumerics is used to resolve the roulette-style game.

A wagering game is played on an electronic system with a processor, a video display screen and a player input system. The processor recognizing a wager, enabling player input at the specific player position. The processor executes code to display a grid of at least 40, preferably at least or exactly 84 frames for display of a unique symbol within each frame of the grid. The preferred 84 frame grid is comprised of the standard 80 frame Keno grid (usually displayed as two 4×10 grids), with 2 frames added to each of these 4×10 grids. The symbols displayed in these 4 additional frames would be eligible for only certain types of wagers, specifically Keno Roulette wagers. The processor accepts roulette-type wagers such as wagers on individual numbers, adjacent numbers (in the grid), lines of numbers (on the grid), columns of numbers (on the grid), even numbers, odd numbers, specific color numbers and the like. The processor executes code and thereby selects and recognizes the random keno numbers (or symbols) and the specific number(s) (or symbols) designated as the roulette-style winner(s); The recognized keno numbers or symbols are compared to the symbol(s) and symbol combinations in the recognized wager selections. The comparisons are made with each of the specific player wagering positions. The number and/or symbol combinations used/selected in the wagers are compared with preselected numbers of selections made in the keno game, and preferably in the order of random selections made.

### BRIEF DESCRIPTION OF THE FIGURES

FIG. 1 is a schematic block diagram illustrating a plurality of gaming terminals in communication with a central controller.

FIGS. 2A to 2C are perspective views of one embodiment of the gaming terminal of the present invention illustrating the player selecting numbers and the gaming terminal generating numbers based on the selected game outcome seed.

A preferred layout (FIG. 3) 2 extra spaces added to each grid displaying 0, 00, X and XX with 4 extra balls added to the 80 balls.

An optional layout (FIG. 4) shows the addition of only 1 extra space added to each grid displaying 0 and X with 2 extra balls added to the 80 balls.

An optional layout (FIG. 5) is a display layout that has a 18×10 grid with 2 extra spaces added displaying 0 and X with 2 extra balls added to the 80 balls.

An optional layout (FIG. 6) is a display layout that has al 8×10 grid with 4 extra spaces added displaying 0, 00, X and XX with 4 extra balls added to the 80 balls.

A betting Display (FIG. 7) showing Roulette-style bet placements used in addition to the keno wagers.

### DETAILED DESCRIPTION OF THE INVENTION

A wagering game is played on an electronic system with a processor, a video display screen and a player input system. The game might be played on a physical gaming table that displays the typical keno grid of 4×20 numbers, 8×10 numbers, or two grids of 4×10 numbers (or a modified grid, showing all the available numbers distributed within the grid). The processor recognizes a wager from a wagering entry system (e.g., a terminal, banks of terminals, internet connections through cellular phones, pads, tablets, and the like), enabling player input at the specific player position or specific player identification. The processor executes code to display a grid of at least 40 (e.g., 42 frames or balls, with 0 and 00 added to 1-40), preferably at least 80 (e.g., 84 frames or balls, with 0, 00, X and XX added to 1-80) frames for display of a unique symbol within each frame of the grid. The processor accepts standard keno wagers and the roulette-type wagers (as side bets or an additional wager) such as wagers on individual numbers, adjacent numbers (in the grid), lines of numbers (on the grid), columns of numbers (on the grid), even numbers, odd numbers, specific color numbers and the like. The processor selects and recognizes the random keno numbers (or symbols) and the specific number(s) (or symbols) designated as the roulette-style winner(s); they are compared to the symbol(s) and symbol combinations in the recognized wager selections. In a unique attribute of this novel technology, the odds may be varied in the game to provide odds similar to comparable wagers in roulette. This is not an obvious variation as in roulette, a single number is selected, and in keno over 10 numbers (typically twenty numbers) are selected. The game engine, game processor and/or processor may execute code to accept wagers for the roulette-type wagers on a specific number, specific group of numbers, and/or specific order of numbers/symbols selected. For example, a wager for a single number may be placed on the first number/symbol selected in the random selection in the keno game (at payout odds less than 79:1 odds), the first two numbers selected in the random selection in the keno game (at payout odds less than 39:1 odds), the first three number (at payout odds less than 26:1 odds), etc. It is also possible for the processor to select or the data received by the processor recognized as having selected any specific numbers in the total predetermined number of selections to be made in the keno game. For example, the processor may identify the seventh (7^{th}) number as the single number, or the player may select the thirteenth number (13^{th}) as the single number roulette event. Similarly where multiple numbers are used in the determination of the roulette-type wager, the processor may select (predetermined or randomly) or recognize the specific numbers during the random selection of the total number of keno numbers. For example, a standard setting would be numbers 1 and 2 selected out of the entire (e.g., 20) group of numbers selected in the keno game. Alternatively, the processor may randomly select or the player may recognize (e.g., from the player/data input system) a specific set of numbers to be used in determining the roulette-type wager outcome, such as 2^{nd} and 3^{rd} numbers, 7^{th} and 13^{th} numbers, etc. on a single number or two number wager. The same types of selections of active numbers on the roulette-type wagers apply to the different number combinations as with line wagers, column wagers, squares (four numbers/symbols in a 2×2 box), odd number wagers, consecutive number wagers, three number wagers and the like.

Another preferred aspect of a method within the scope of the invention includes selecting the numbers for the roulette event, and for the processor to recognize the first Keno number selected as the first roulette event number. When using the preferred grid and frame arrangement of two 4×10 grids with 2 additional frames each, the processor determines which grid the first roulette event number falls into; the processor then determines the next selected Keno number that falls into the other grid and then recognizes that number as the second roulette event number. Also in a preferred method, if any of the first 20 called Keno numbers are a 0, 00, X, or XX (the additional 4 symbols added), additional/replacement numbers could be called so that there are 20 eligible Keno numbers called. It is not desirable to alter the basic underlying Keno component of the game.

The comparisons are made with each of the specific player wagering positions. The number and/or symbol combinations used/selected in the wagers are compared with preselected numbers of selections made in the keno game, and preferably in the order of random selections made. The underlying keno game may also be varied if desired. In this way, at least 10 symbols may be selected by the processor, at least 12, at least 15 and the like. The processor displays a first arrangement of available unique symbols (e.g., artistic symbols or alphanumerics) within each frame prior to recognizing selection at the specific player position, and the processor displays the specific symbols wagered upon in the keno game and the roulette type wagers. The processor may highlight each of the originally available numbers, the keno wager-selected numbers, the roulette-type wager-selected numbers and the randomly selected numbers in the keno game and the randomly selected numbers active in the roulette-type game.

For example, the numbers in the field may be originally displayed as black numbers on a white field. The numbers wagered upon for the keno game may then become black numbers on a grey field. The numbers wagered upon in the roulette-type wager may then be highlighted yellow (within the field or around the edges). The yellow highlighting and the gray field would still be apparent when a single frame was involved in both wagers. When a number is selected for keno-only wagers (not a roulette-active number), the number on the grid may flash. When a number is selected for both the keno play and the roulette play, the edge may flash red. In this way, the individual activity of the individual frames is clearly and distinctly identified. Thus, on a single grid, there will be at least black numbers on a white field (non-selected numbers and inactive numbers), black numbers on a gray field (keno wager-selected numbers that were not matched with a randomly selected active number), gray fields with yellow highlighting (with selected keno-wager numbers and flashing field for keno-only selection), white flashing field (with non-wager-selected numbers and a randomly selected keno number), white field with a red flashing edge (with non-wager-selected numbers and a randomly selected roulette number), a white field with flashing field and red flashing edge (with non-wager-selected numbers and a randomly selected keno-active and roulette-active number), gray fields with flashing field and red flashing edge (with wager-selected numbers and a randomly selected keno-active and roulette-active number), and the like. Alternatively, two screens can be displayed, one displaying Keno picks and results, and the second displaying roulette-type wagers and results.

An example of a gaming system within the scope of the present technology includes a gaming system with a processor (which may be in communication with a random number generator and wager resolver), player input position and a video display system, wherein:
the processor may be configured to execute code to recognize a wager at a player input position on a first wagering game (e.g., keno);
the processor may be configured to recognize and display on the video display system a grid of alphanumerics, each alphanumeric within a frame within a grid on which wagers may be placed;
the processor may be configured to recognize and display on the video display system alphanumerics identified by signals from the player input position as an object of wagers on both a) an underlying game selected from the group consisting of bingo and keno games and b) specific alphanumerics groups that consist of a subgroup of alphanumerics that may not constitute a winning event outcome in the underlying game; (Examples of such non-underlying wagers may be at least five [or more] consecutive numbers being selected, at least a specific number [e.g., 7 or more] even numbers being selected out of the 10 numbers selected; all prime numbers being selected; any 3×3 combination of numbers in the array; and any other unique event that does not require wagering on specific numbers as done in a keno wager)
the processor may be configured to recognize and display with a first distinction on the video display system each individual alphanumeric that is the object of wagers on b);
the processor may be configured to recognize and display on the video display system with a second distinction randomly selected alphanumerics for the underlying game, wherein the randomly selected alphanumerics are used in outcome determination in an underlying wagering game selected from the group consisting of bingo, keno and variants of bingo and keno;
the processor may be configured to recognize and display on the video display system with a third distinction randomly selected alphanumerics for a side bet game that is the object of b);
the processor displaying with distinguishing highlights the randomly selected alphanumerics for a) and b) on the screen to display outcome results for the underlying wagering game and the side bet game;
the processor contemporaneously displaying on the video display system i) original alphanumerics on which no wager has been placed, and for which no randomly selected alphanumeric has been chosen, ii) original alphanumerics on which no wager has been placed, and for which a randomly selected alphanumeric has been chosen for the underlying game; iii) original alphanumerics on which no wager has been placed, and for which a randomly selected alphanumeric has been chosen for the side bet game b), iv) original alphanumerics on which a wager has been placed for the underlying game and for which no randomly selected alphanumeric has been chosen, v) original alphanumerics on which a wager has been placed for the side bet game b) and for which no randomly selected alphanumeric has been chosen, vi) original alphanumerics on which a wager has been placed for the underlying game and for which a randomly selected alphanumeric has been chosen in play of the underlying game, vii) original alphanumerics on which a wager has been placed for the side bet game b) and for which a randomly selected alphanumeric has been chosen for use in the underlying game, and viii) original alphanumerics on which a wager has been placed in the side bet game b) and for which a randomly selected alphanumeric has been chosen for use in the side bet game b); (In an optional methodology, there may be two separate screens or two separate areas in a single screen, or alternative displays on a single screen of the keno picks and outcomes and the roulette picks and outcomes.)
the processor comparing outcomes of the randomly selected alphanumerics with alphanumerics selected in wagers on a) and b); and
the processor executing code to resolve the wagers a) and b) at player input positions on the underlying wagering game and the side bet game b) based on correspondence of alphanumerics selected in wagers a) and b) and the alphanumerics that have been randomly chosen by the processor.
   The underlying game may be keno or bingo and physical balls are randomly selected and electronic signals of the physical balls selection outcomes are provided as signals to the processor to enable the processor to recognize balls selected as the randomly selected alphanumerics.

Where the underlying game is keno, virtual number selections may be made by a random number generator in communication with the processor and electronic signals of the virtual number selection outcomes are provided as signals to the processor to enable the processor to recognize the virtual numbers selected as the randomly selected alphanumerics. Where the underlying game is bingo, virtual bingo balls may be randomly selected by a random number generator and electronic signals of the virtual balls selection outcomes are provided as signals to the processor to enable the processor to recognize balls selected as randomly selected alphanumerics. The gaming system may have a player input position comprising a stationary terminal with a wager selecting system selected from the group consisting of buttons and touchscreens, or the player input position comprises a hand-held wireless data entry system or a laptop computer data entry system with a wager selecting system selected from the group consisting of buttons and touchscreens.

In the play of keno, exactly 20 ball selections may be used as the randomly selected alphanumerics and the 20 random alphanumeric selections are displayed on the video display system as a distinct image feature on each frame in the grid on the video display system. The processor may be configured to execute code so that distinguishing image characteristics are provided to each of the displayed images of i), ii), iii), iv), v), vi), vii) and viii) so that each of the displayed images can be readily distinguished from one another with respect to activity of a specific alphanumeric in a frame on the grid with respect to other alphanumerics having a different activity.

The gaming system may include wagers on the specific alphanumerics groups that consist of a subgroup of alphanumerics that may not constitute a winning event outcome in the underlying game. Examples of such wagers are selected from the group consisting of A) a single alphanumeric; B) a specific pair of alphanumerics in adjacent frames; C) a specific triplet of alphanumerics in connected frames; D) a specific quad of alphanumerics; E) specific alphanumerics within a linear aligned set of at least three frames of alphanumerics within the grid; F) specific value groups of alphanumerics such as even numbers, odd numbers, lowest portion of the entire set of alphanumerics, highest value portion of the entire set, etc.; G) specific groups of alphanumerics based on display features such as color or size; H) and the like; and the wagers are placed on a predetermined winning outcome selected from the group consisting of i) a single random alphanumeric within the set of random alphanumerics selected for the underlying game; ii) at least two but no more than twenty random alphanumerics within the set of random alphanumerics selected for the underlying game; iii) a single random alphanumeric separately selected from the set of random alphanumerics selected for the underlying game; iv) at least two but no more than twenty random alphanumerics separately selected from the set of random alphanumerics selected for the underlying game.

### An Alternative Embodiment of a Method

Keno Roulette is played using the underlying rules of Standard Keno with a few modifications. The game is played on a modified Keno grid. The standard Keno grid is composed of two 4×10 grids. The first grid displays numbers 1 through 40 and the second grid displays numbers 41 through 80.

This layout is then modified by adding 2 extra spaces to each of the 2 grids.

The first grid will add 0 and 00 (by way of non-limiting example). The second grid will add X and XX. (By way of non-limiting example)

These extra grid spaces will be represented by 4 extra balls added to the 80 standard balls in the game of Keno for a total of 84 balls.

The 2 grids with 42 symbols in each will represent 2 separate roulette layouts for Keno Roulette.

20 balls will be called for Keno as in a standard game. Players are unable to wager on the 0, 00, X, and XX for Keno.

If any of these 4 balls are called, they will be replaced with additional balls (by additional selection of balls in the underlying game) until there are 20 eligible Keno numbers called. (It is also possible to adjust payout odds so that none or less than all of 0, 00, X or XX are replaced, but with higher payout odds given in the underlying keno game).

The first 2 balls drawn for the Keno game will represent the winning numbers for Keno-Roulette.

### Keno Roulette Wagers

Player may make wagers similar to those in a Roulette Game on either of the 2 grids.

Sample bets below.
20 horizontal numbers: placing a chip on the outside line of the grid and between two rows of 10 numbers; pays 2 for 1.
10 horizontal numbers: placing a chip on the outside line of the grid on the 1st number in a row of 10 numbers; pays 4 for 1.
8 vertical numbers: placing a chip on the outside line of the grid and between two columns of 4 numbers; pays 5 for 1.
4 vertical numbers: placing a chip on the outside line of the grid on the 1st number in a column of 4 numbers; pays 10 for 1.
4 numbers: placing a chip on the intersecting corner of 4 numbers; pays 10 for 1.
2 numbers: placing a chip on the line between 2 numbers; pays 20 for 1.
1 number: placing a chip on the number; pays 40 for 1.
Player may also wager that he will pick both active Roulette numbers.
Player may also wager that both numbers will be even or odd.
Player may also wager that both numbers will be 1 to 40 or 41 to 80.

A Player may have the option to wager on only the 1st Roulette number called, doubling the winnings.

Optional draw method for Roulette numbers:

Instead of the first 2 balls called for Keno, the 2 active roulette numbers may be represented by the first ball that is drawn to each of the 2 grids.

FIGURES show:

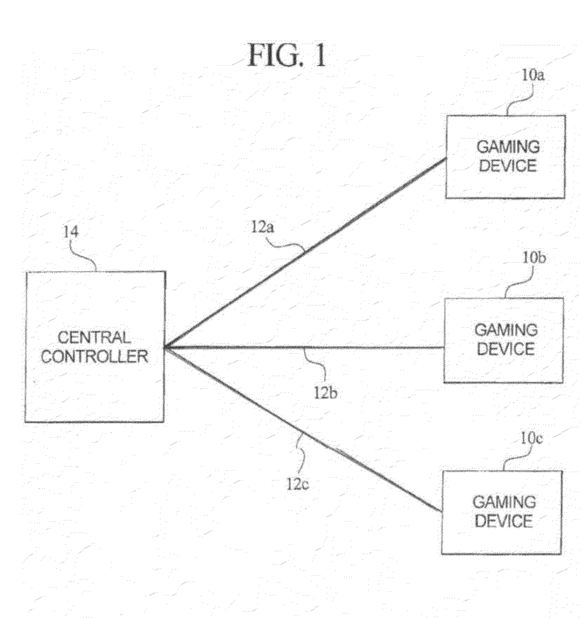

FIG. 1 is a schematic block diagram illustrating a plurality of gaming terminals in communication with a central controller.

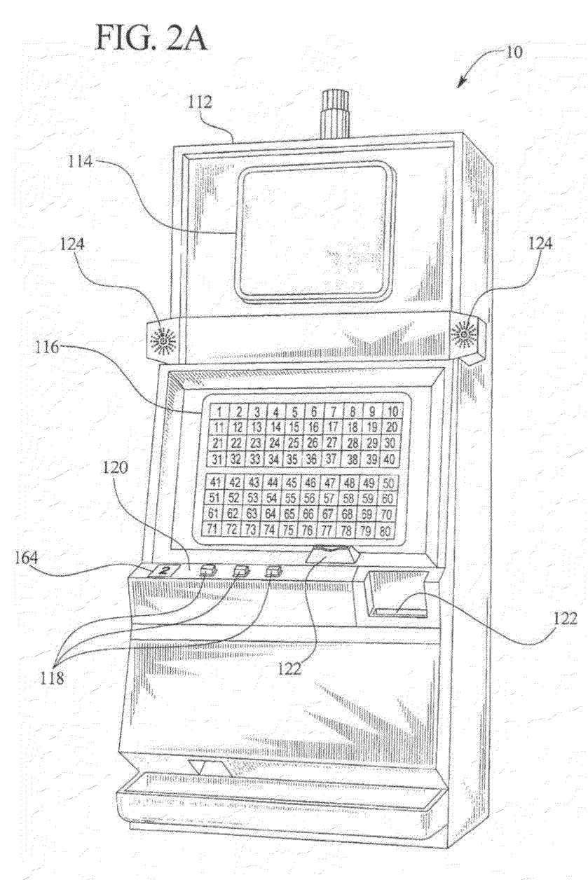

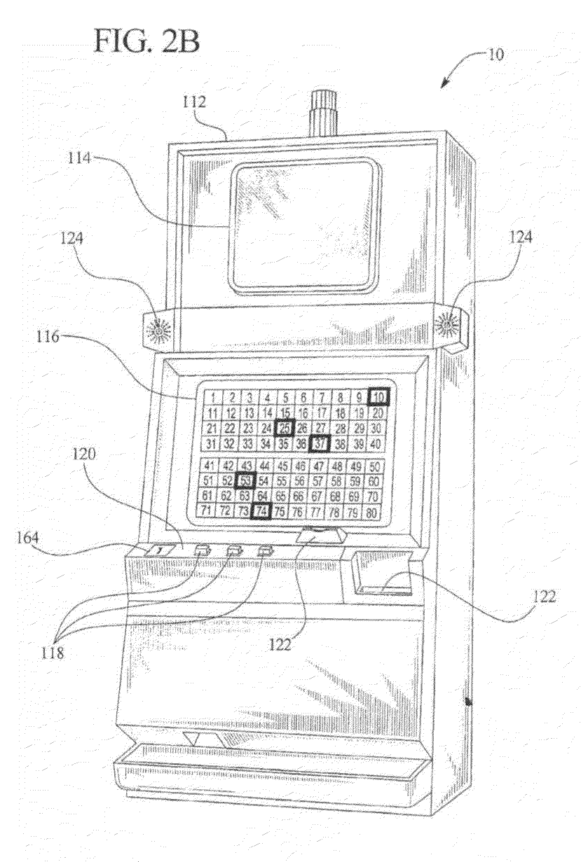

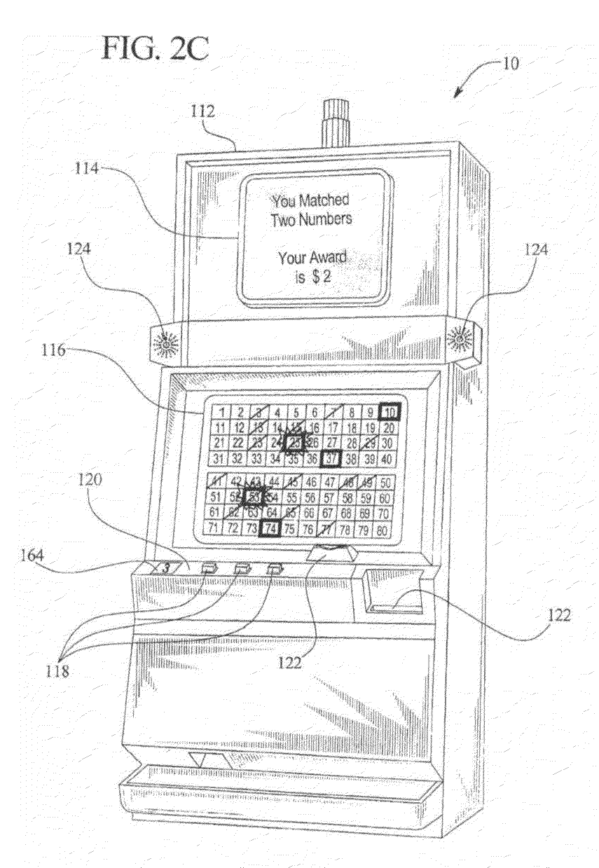

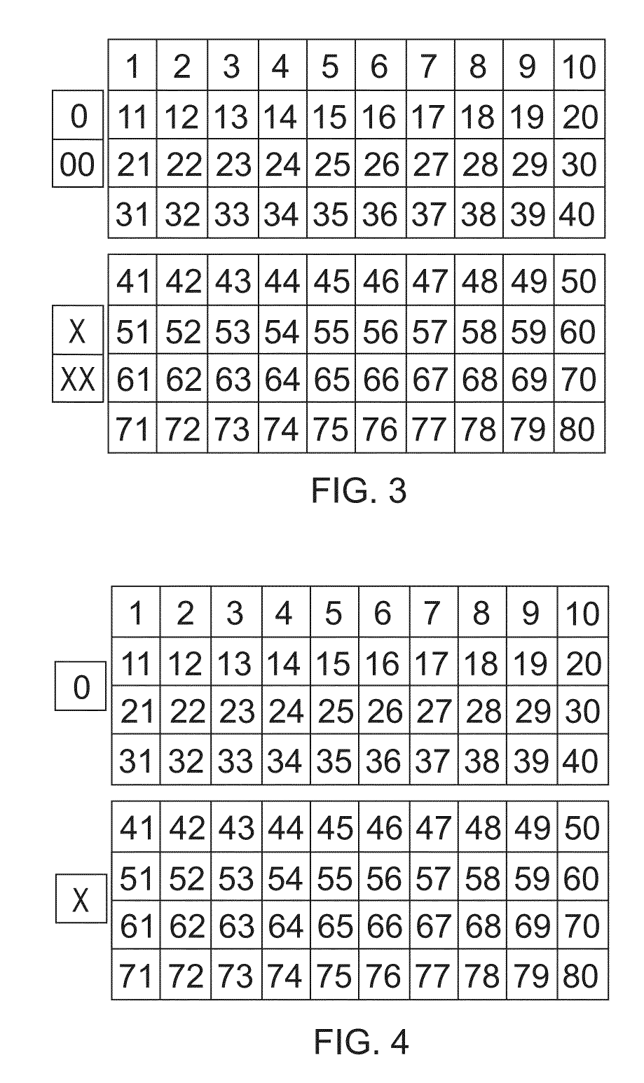

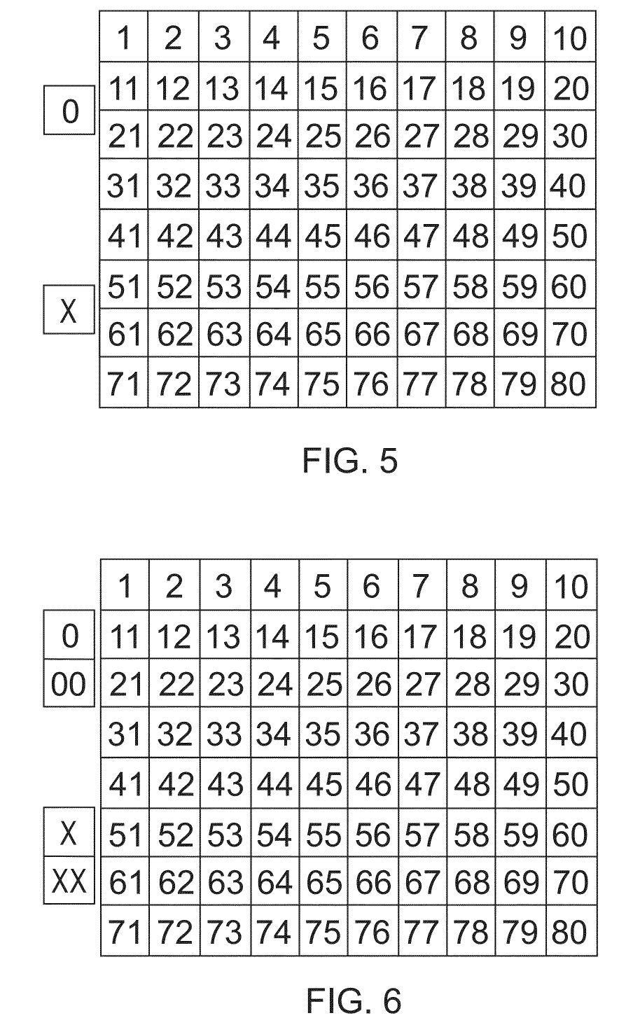

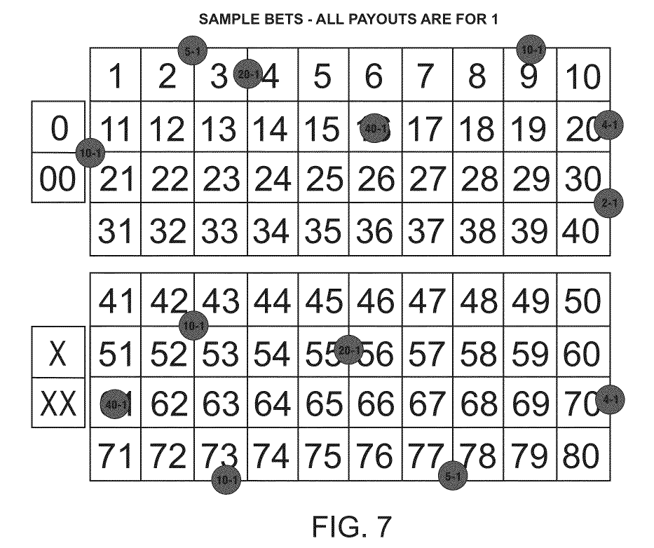

FIGS. 2A to 2C are perspective views of one embodiment of the gaming terminal of the present invention illustrating the player selecting numbers and the gaming terminal generating numbers based on the selected game outcome seed.

A preferred layout (FIG. 3) 2 extra spaces added to each grid displaying 0, 00, X and XX with 4 extra balls added to the 80 balls.

An optional layout (FIG. 4) shows the addition of only 1 extra space added to each grid displaying 0 and X with 2 extra balls added to the 80 balls.

An optional layout (FIG. 5) is a display layout that has a 1 8×10 grid with 2 extra spaces added displaying 0 and X with 2 extra balls added to the 80 balls.

An optional layout (FIG. 6) is a display layout that has a 1 8×10 grid with 4 extra spaces added displaying 0, 00, X and XX with 4 extra balls added to the 80 balls.

A betting Display (FIG. 7) showing Roulette-style bet placements used in addition to the keno wagers.

Another general description of the technology is a method of gaming played on a gaming system comprising a processor, player input position and a video display system, wherein:

the processor is configured to execute code to recognize a wager at a player input position on a first wagering game;

the processor is configured to recognize and display on the video display system a grid of alphanumerics, each alphanumeric within a frame within a grid on which wagers may be placed;

the processor is configured to recognize and display on the video display system alphanumerics identified by signals from the player input position as an object of wagers on both a) an underlying game selected from the group consisting of bingo games and keno games and b) specific alphanumeric groups that consist of a subgroup of alphanumerics that are not evaluated by the processor as constituting a winning event outcome in the underlying game;

the processor is configured to recognize and display with a first distinguishing characteristic the video display system each individual alphanumeric that is the object of wagers on b);

the processor is configured to recognize and display on the video display system with a second distinguishing characteristic each randomly selected alphanumeric for use in determining outcomes in the underlying game;

the processor is configured to recognize and display on the video display system with a third distinguishing characteristic randomly selected alphanumerics for a side bet game that is the object of wagers on b);

the processor displaying with the first, second and third distinguishing highlights the randomly selected alphanumerics for a) and b) on the screen to display outcome results for the underlying wagering game and the side bet game;

the processor contemporaneously displaying on the video display system using the first, second and third distinguishing characteristics:
i) original alphanumerics on which no wager has been placed, and for which no randomly selected alphanumeric has been chosen,
ii) original alphanumerics on which no wager has been placed, and for which a randomly selected alphanumeric has been chosen for the underlying game;
iii) original alphanumerics on which no wager has been placed, and for which a randomly selected alphanumeric has been chosen for the side bet game b),
iv) original alphanumerics on which a wager has been placed for the underlying game and for which no randomly selected alphanumeric has been chosen,
v) original alphanumerics on which a wager has been placed for the side bet game b) and for which no randomly selected alphanumeric has been chosen,
vi) original alphanumerics on which a wager has been placed for the underlying game and for which a randomly selected alphanumeric has been chosen in play of the underlying game,
vii) original alphanumerics on which a wager has been placed for the side bet game b) and for which a randomly selected alphanumeric has been chosen for use in the underlying game, and
viii) original alphanumerics on which a wager has been placed in the side bet game b) and for which a randomly selected alphanumeric has been chosen for use in the side bet game b);

the processor comparing outcomes of the randomly selected alphanumerics with alphanumerics selected in wagers on a) and b); and

the processor executing code to resolve the wagers a) and b) at player input positions on the underlying wagering game and the side bet game b) based on correspondence of alphanumerics selected in wagers a) and b) and the alphanumerics that have been randomly chosen by the processor.

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming device or gaming machine disclosed herein is operable over a wireless network, such as part of a wireless gaming system. In this embodiment, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a bingo game. In this embodiment, a bingo server calls the bingo balls that result in a specific bingo game outcome. The resultant game outcome is communicated to the individual gaming device to be provided to a player. In one embodiment, this bingo outcome is displayed to the player as a bingo game and/or in any form in accordance with the present disclosure.

In one embodiment, the gaming device includes one or more display devices controlled by the processor. The display devices are preferably connected to or mounted to the cabinet of the gaming device. The embodiment includes a central display device which displays a primary game. This display device may also display any suitable secondary game associated with the primary game as well as information relating to the primary or secondary game. The upper display device may display the primary game, any suitable secondary game associated or not associated with the primary game and/or information relating to the primary or secondary game. These display devices may also serve as digital glass operable to advertise games or other aspects of the gaming establishment. In one embodiment, the gaming device includes a credit display which displays a player's current number of credits, cash, account balance or the equivalent. In one embodiment, the gaming device includes a bet display which displays a player's amount wagered. In one embodiment, as described in more detail below, the gaming device includes a player tracking display which displays information regarding a player's playing tracking status.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display based on a plurality of surface-conduction electron-emitters (SEDs), a display including a projected and/or reflected image or any other suitable electronic device or display mechanism. In one embodiment, the display device includes a touch-screen with an associated touch-screen controller. The display devices may be of any suitable size and configuration, such as a square, a rectangle or an elongated rectangle.

The general scope of the invention may include methods and systems as follows. A method of playing a wagering game on an electronic gaming system may have, for example:
a) a central processor;
b) a video display system;
c) data entry systems in communication with the central processor;
d) an electronic random number generator in communication with the central processor; and
e) memory containing look-up tables of event result tables.

Although specific examples are provided, those examples are intended to be only examples of species within a generic invention and are not to be read as narrowly limiting the scope of the invention unless specifically recited in claims.

What is claimed:

1. A gaming system comprising a processor, player input position and a video display system, wherein:
the processor is configured to execute code to recognize a wager at a player input position on a first wagering game on at least one array comprising columns and rows;
the processor is configured to recognize and display on the video display system a grid of alphanumerics in the array, each alphanumeric within a frame within a grid on which wagers may be placed;
the processor is configured to recognize and display on the video display system alphanumerics identified by signals from the player input position as an object of wagers on both a) an underlying game selected from the group consisting of bingo games and keno games and b) specific alphanumeric groups that consist of a subgroup of alphanumerics that are not evaluated by the processor as constituting a winning event outcome in the underlying game;
the processor is configured to recognize and display with a first distinguishing characteristic on the video display system each individual alphanumeric or groups of alphanumerics that is the object of wagers on b);
the processor is configured to recognize and display on the video display system with a second distinguishing characteristic each randomly selected alphanumeric for use in determining outcomes in the underlying game;
the processor is configured to recognize and display on the video display system with a third distinguishing characteristic randomly selected alphanumerics for use in determining outcomes for a side bet game that is the object of wagers on b);
the processor displaying with the first, second and third distinguishing highlights the randomly selected alphanumerics for a) and b) on the screen to display outcome results for the underlying wagering game and the side bet game;
the processor contemporaneously displaying on the video display system using the first, second and third distinguishing characteristics:
i) original alphanumerics on which no wager has been placed, and for which no randomly selected alphanumeric has been chosen,
ii) original alphanumerics on which no wager has been placed, and for which a randomly selected alphanumeric has been chosen for the underlying game;
iii) original alphanumerics on which no wager has been placed, and for which a randomly selected alphanumeric has been chosen for the side bet game b),
iv) original alphanumerics on which a wager has been placed for the underlying game and for which no randomly selected alphanumeric has been chosen,
v) original alphanumerics on which a wager has been placed for the side bet game b) and for which no randomly selected alphanumeric has been chosen,
vi) original alphanumerics on which a wager has been placed for the underlying game and for which a randomly selected alphanumeric has been chosen in play of the underlying game,
vii) original alphanumerics on which a wager has been placed for the side bet game b) and for which a randomly selected alphanumeric has been chosen for use in the underlying game, and
viii) original alphanumerics on which a wager has been placed in the side bet game b) and for which a randomly selected alphanumeric has been chosen for use in the side bet game b);
the processor comparing outcomes of the randomly selected alphanumerics with alphanumerics selected as wagers on a) and b); and
the processor executing code to resolve the wagers a) and b) at player input positions on the underlying wagering game and the side bet game b) based on correspondence of alphanumerics selected as wagers on a) and b) and the alphanumerics that have been randomly chosen by the processor.

2. The gaming system of claim 1 wherein the array is used in an underlying game selected from the group consisting of Keno, Bingo, Keno variants and Bingo variants.

3. The gaming system of claim 2 wherein the underlying game is bingo and physical balls are randomly selected and electronic signals of the physical balls selection outcomes are provided as signals to the processor to enable the processor to recognize balls selected as the randomly selected alphanumerics.

4. The gaming system of claim 2 wherein the underlying game is keno and physical balls are randomly selected and electronic signals of the physical balls selection outcomes are provided as signals to the processor to enable the processor to recognize balls selected as randomly selected alphanumerics.

5. The gaming system of claim 1 wherein the underlying game is keno and virtual number selections are made by a random number generator in communication with the processor and electronic signals of the virtual number selection outcomes are provided as signals to the processor to enable the processor to recognize the virtual numbers selected as the randomly selected alphanumerics.

6. The gaming system of claim 1 wherein the underlying game is bingo and virtual bingo balls are randomly selected by a random number generator and electronic signals of the virtual balls selection outcomes are provided as signals to the processor to enable the processor to recognize balls selected as randomly selected alphanumerics.

7. The gaming system of claim 2 wherein the player input position comprises a stationary terminal with a wager selecting system selected from the group consisting of buttons and touchscreens.

8. The gaming system of claim 2 wherein the player input position comprises a hand-held wireless data entry system or a laptop computer data entry system with a wager selecting system selected from the group consisting of buttons and touchscreens.

9. The gaming system of claim 5 wherein exactly 20 ball selections are used as the randomly selected alphanumerics and the 20 random alphanumeric selections are displayed on the video display system as a distinct image feature on each frame in the grid on the video display system.

10. The gaming system of claim 2 wherein the processor is configured to execute code so that distinguishing image characteristics are provided to each of the displayed images of i), ii), iii), iv), v), vi), vii) and viii so that each of the displayed images can be readily distinguished from one another with respect to activity of a specific alphanumeric in a frame on the grid with respect to other alphanumerics having a different activity.

11. The gaming system of claim 5 wherein the processor is configured to execute code so that distinguishing image characteristics are provided to each of the displayed images of i), ii), iii), iv), v), vi), vii) and viii so that each of the displayed images can be readily distinguished from one another with respect to activity of a specific alphanumeric in a frame on the grid with respect to other alphanumerics having a different activity.

12. The gaming system of claim 5 wherein the wagers on the specific alphanumerics groups that consist of a subgroup of alphanumerics that may not constitute a winning event outcome in the underlying game are selected from the group consisting of A) a single alphanumeric B) a specific pair of alphanumerics in adjacent frames; C) a specific triplet of alphanumerics in connected frames; D) a specific quad of alphanumerics; E) specific alphanumerics within a linear aligned set of at least three frames of alphanumerics within the grid; F) specific value groups of alphanumerics such as even numbers, odd numbers, lowest portion of the entire set of alphanumerics, highest value portion of the entire set, etc.; G) specific groups of alphanumerics based on display features such as color or size; H) and the like; and the wagers are placed on a predetermined winning outcome selected from the group consisting of i) a single random alphanumeric within the set of random alphanumerics selected for the underlying game; ii) at least two but no more than twenty random alphanumerics within the set of random alphanumerics selected for the underlying game; iii) a single random alphanumeric separately selected from the set of random alphanumerics selected for the underlying game; iv) at least two but no more than twenty random alphanumerics separately selected from the set of random alphanumerics selected for the underlying game.

13. The gaming system of claim 7 wherein the wagers on the specific alphanumerics groups that consist of a subgroup of alphanumerics that may not constitute a winning event outcome in the underlying game are selected from the group consisting of A) a single alphanumeric B) a specific pair of alphanumerics in adjacent frames; C) a specific triplet of alphanumerics in connected frames; D) a specific quad of alphanumerics; E) specific alphanumerics within a linear aligned set of at least three frames of alphanumerics within the grid; F) specific value groups of alphanumerics such as even numbers, odd numbers, lowest portion of the entire set of alphanumerics, highest value portion of the entire set, etc.; G) specific groups of alphanumerics based on display features such as color or size; H) and the like; and the wagers are placed on a predetermined winning outcome selected from the group consisting of i) a single random alphanumeric within the set of random alphanumerics selected for the underlying game; ii) at least two but no more than twenty random alphanumerics within the set of random alphanumerics selected for the underlying game; iii) a single random alphanumeric separately selected from the set of random alphanumerics selected for the underlying game; iv) at least two but no more than twenty random alphanumerics separately selected from the set of random alphanumerics selected for the underlying game.

14. The gaming system of claim 10 wherein the wagers on the specific alphanumerics groups that consist of a subgroup of alphanumerics that may not constitute a winning event outcome in the underlying game are selected from the group consisting of A) a single alphanumeric B) a specific pair of alphanumerics in adjacent frames; C) a specific triplet of alphanumerics in connected frames; D) a specific quad of alphanumerics; E) specific alphanumerics within a linear aligned set of at least three frames of alphanumerics within the grid; F) specific value groups of alphanumerics such as even numbers, odd numbers, lowest portion of the entire set of alphanumerics, highest value portion of the entire set, etc.; G) specific groups of alphanumerics based on display features such as color or size; H) and the like; and the wagers are placed on a predetermined winning outcome selected from the group consisting of i) a single random alphanumeric within the set of random alphanumerics selected for the underlying game; ii) at least two but no more than twenty random alphanumerics within the set of random alphanumerics selected for the underlying game; iii) a single random alphanumeric separately selected from the set of random alphanumerics selected for the underlying game; iv) at least two but no more than twenty random alphanumerics separately selected from the set of random alphanumerics selected for the underlying game.

15. A method of playing a side bet wagering game on a gaming system comprising a video display system, a processor and a data entry input system at a defined location, the method comprising:
a wager on an underlying game selected from the group consisting of keno, bingo or keno/bingo variants is received by a wager resolver in communication with the processor;
the processor is configured to recognize and display on the video display system a grid of alphanumerics, each alphanumeric within a frame within a grid on which wagers may be placed;
the processor recognizes and displays on the video display system alphanumerics identified by signals from the player input position as an object of wagers on both a) an underlying game selected from the group consisting of bingo and keno games and b) specific alphanumerics groups that consist of a subgroup of alphanumerics that are not evaluated by the processor as constituting a winning event outcome in the underlying game;
the processor recognizes and displays with a first distinction on the video display system each individual alphanumeric that is the object of wagers on b);
the processor recognizes and displays on the video display system with a second distinction randomly selected alphanumerics for the underlying game, wherein the randomly selected alphanumerics are used in outcome determination in an underlying wagering game selected from the group consisting of bingo, keno and variants of bingo and keno;
the processor recognizes and displays on the video display system with a third distinction randomly selected alphanumerics used in outcome determination for a side bet game that is the object of wagers on b);
the processor displaying with distinguishing highlights the randomly selected alphanumerics for a) and b) on the screen to display outcome results for the underlying wagering game and the side bet game;
the processor contemporaneously displaying on the video display system:
i) original alphanumerics on which no wager has been placed, and for which no randomly selected alphanumeric has been chosen,
ii) original alphanumerics on which no wager has been placed, and for which a randomly selected alphanumeric has been chosen for the underlying game;
iii) original alphanumerics on which no wager has been placed, and for which a randomly selected alphanumeric has been chosen for the side bet game b),
iv) original alphanumerics on which a wager has been placed for the underlying game and for which no randomly selected alphanumeric has been chosen,
v) original alphanumerics on which a wager has been placed for the side bet game b) and for which no randomly selected alphanumeric has been chosen,
vi) original alphanumerics on which a wager has been placed for the underlying game and for which a randomly selected alphanumeric has been chosen in play of the underlying game,
vii) original alphanumerics on which a wager has been placed for the side bet game b) and for which a randomly selected alphanumeric has been chosen for use in the underlying game, and
viii) original alphanumerics on which a wager has been placed in the side bet game b) and for which a randomly selected alphanumeric has been chosen for use in the side bet game b);
the processor comparing outcomes of the randomly selected alphanumerics with alphanumerics selected as wagers on a) and b); and
the processor executing code to resolve the wagers a) and b) at player input positions on the underlying wagering game and the side bet game b) based on correspondence of alphanumerics selected as wagers on a) and b) and the alphanumerics that have been randomly chosen by the processor.

16. A method of playing a side bet wagering game on a gaming system comprising a video display system, a processor and a data entry input system at a defined location, the method comprising:
a first wager on an underlying game of keno, bingo or keno/bingo variants is received by a wager resolver in communication with the processor;
the processor is configured to recognize and display on the video display system a grid of alphanumerics, each alphanumeric within a frame within a grid on which wagers may be placed; wherein:
a second wager or wagers on a roulette-style side bet game is received by a wager resolver in communication with the processor;
the processor providing a virtual grid of alphanumerics from the group consisting of a) 40 keno alphanumerics and an additional 1 or 2 alphanumerics not used in the play of keno and b) 80 keno alphanumerics and an additional 2 or 4 alphanumerics not used in the play of keno;
the data input system placing a first wager A) on data input selected alphanumerics to be used in keno, the selection being made from a) the 40 alphanumerics or b) the 80 alphanumerics;
the data input system placing a second wager or wagers B) on a roulette-style game on alphanumerics selection being made on a) the 40 keno alphanumerics and an additional 1 or 2 alphanumerics not used in the play of keno or b) the 80 keno alphanumerics and the additional 2 or 4 alphanumerics not used in the play of keno;
the processor randomly selecting at least 10 numbers on first wager A) to resolve a) the 40 keno alphanumerics and an additional 1 or 2 alphanumerics not used in the play of keno or at least 20 numbers on first wager A) used to resolve b) the 80 keno alphanumerics and the additional 2 or 4 alphanumerics not used in the play of keno;
wherein a predetermined one or more of the at least 10 numbers is used to resolve wager B) against an a) 40 plus an additional 1 or 2 alphanumerics roulette-style game or b) 80 plus an additional 2 or 4 alphanumerics roulette-style game.

17. The method of claim 16 wherein at least the 40 alphanumerics and the 80 alphanumerics comprise consecutive numbers on which the keno wager A) is placed and which are randomly selected by the processor.

18. The method of claim 15 wherein wager B) in the roulette-style game is resolved against two numbers selected from the at least 20 random alphanumerics in play of the 80 plus 0, 00, X and XX alphanumeric grid.

19. The method of claim 16 wherein wager B) in the roulette-style game is resolved against only one number selected from the at least 20 random alphanumerics in play of the 80 plus 0, 00, X and XX alphanumeric grid.
